(19) United States
(12) Patent Application Publication
(10) Pub. No.: US 2010/0254364 A1
(43) Pub. Date: Oct. 7, 2010

(54) RATE-ADAPTIVE METHOD FOR WIRELESS MESH NETWORK

(76) Inventors: Ping Yi, (US); Shuai Zhang, (US); Yue Wu, (US); Jianhua Li, (US)

Correspondence Address: Ping Yi;School of Information Security Eng., SJTU, 800 Dongchuan Road, Shanghai, 200240, omitted

(21) Appl. No.: 12/816,506

(22) Filed: Jun. 16, 2010

(51) Int. Cl. H04W 84/00

(52) U.S. Cl. 370/338

(57) ABSTRACT

This invention relates to a rate-adaptive method for wireless mesh network in areas of wireless networking technology. In the invention, each node in the wireless mesh network broadcasts probe packets and meanwhile receives probe packets from its neighboring nodes, and maintains a rate priority table in time based on the sending success ratio of probe packets, and then sets up a new dynamic probe queue according to this rate priority table, selectively sending all the probes with rates that are listed in the rate priority table or close to them, and the automatic rate selection is accomplished by decisions on probes' sending success ratio. This invention can adapt to the changes of the network conditions very well, and reduce the influence of route broadcast and convergence on network throughput as much as possible, and at the meantime, it takes the changes in network topology into account, thus is very suitable for conditions with a complex spatial distribution of electromagnetic waves.

### FIELD OF THE INVENTION

This invention relates to a method of wireless network technology, namely, a rate-adaptive method over wireless Mesh networks.

### DESCRIPTION OF THE RELATED ART

Wireless Mesh network, also known as “multi-hop” network, is a new wireless network technology. In the traditional wireless LAN (WLAN—wireless local area network), each client accesses the network through a wireless link connecting with AP (access point). If two clients want to communicate with each other, they must first contact with a fixed AP. Such a network structure is known as single-hop network. On the contrary, in Mesh network, every wireless device can act as AP and router. Nodes in the network can both send and receive messages. Everyone is able to communicate directly with other peer node.

The key issue of the rate-adaptive method over wireless Mesh networks is to obtain the time-varying Channel State Information (CSI). Currently there are two main approaches to obtain CSI in wireless Mesh Network based on IEEE 802.11 standard: the one based on direct measurement and the one based on statistics.

The approach based on direct measurement is to directly measure the information about the channel, such as signal to noise (SNR), received signal strength (RSS) or bit error rate (BER), and thus can quickly respond to the channel state. For example, in RBAR protocol proposed by G.Hol-land (with rate-adaptive wireless LAN Media Access Control protocol), the receiver measures the SNR of the RTS (Request to Send) it receives, selects the appropriate rate, and then send that selection information back to the sender through the CTS (Clear to Send) frame. The main disadvantages of such approach are that obtaining the SNR accurately is difficult, and that the protocol forcibly requires RTS/CTS handshake, which will introduce extra overhead. In addition, RBAR protocol requires modifying the IEEE 802.11 standard, which constrains its popularity among manufacturers.

The method based on statistic information is to count certain information sent within a period of time, such as frame error rate, ACK (Acknowledge Character), the number of successful receipts, throughputs, etc., as a basis to estimate the quality of wireless channels. A significant advantage of this method lies in its simplicity and convenience, which can be realized by writing driver software.

In the article “Multi-rate wireless LAN rate-adaptive algorithm” (“Computer Engineering” in April 2007, 33 Volume 8, Article ID: 1000-3428 (2007) -08-0033-03), Duan Zhongxin and Zhang Yun presented a rate-adaptive method over wireless network, using data fusing technique, through real-time detection and estimation on RSS, CIR and PER, and inference under fuzzy logic on each parameter, to form a single parameter to determine the partial channel quality. The integrated analysis and decision-making rules of the fusion center finally determine the sending rate. The technology is targeted at a relatively high hardware performance with hardware platform, and only requires to follow the 802.11b standard. In this technology, the applicable maximum rate is 11 Mbps.

### SUMMARY OF THE INVENTION

An object of the present invention is to overcome at least some of the drawbacks relating to the compromise designs of prior art methods as discussed above.

The purpose of the present invention is to overcome the deficiencies of existing technology, and to provide a rate-adaptive method over wireless Mesh networks to solve the problem of poor rate adaption for single channel in a complex topology. In the present invention, each node at the same time both broadcasts its probe packets and receives such packets from neighbors. According to the success ratio of probe packets, each node maintains a priority list of ratio for all adjacent nodes. The introduction of periodical probe detection mechanism and dynamic probe-queue mechanism ensures that success-ratio of probe can accurately reflect link state. Therefore, nodes in the network could detect the change of link state, realize the rate adaption based on statistic information, and on the other hand timely amend detection mechanism.

The present invention is achieved through the following technology solutions, including the following steps:

Step 1, the network initialization starts. Each node in the wireless Mesh network loads on a probe queue containing all kinds of communication rate supported by 802.11. Each node sends probes periodically and receives probes from other nodes, marking them as neighbor nodes.

The probe packets is a broadcast data packet, which contains node ID (identifier) of its sender, SNR and other physical information, as well as configuration information of the probe and receipt-rate of probes from other nodes.

The configuration information of probe described in the package includes its sending delay, sending interval and the amount of all types of probes sent among the probe packet inspection cycle of the local node. So, the probe packet can not only be used as Hello packets to state its existence and as the link to maintain the data base, but also can inform each node of the other nodes' reception rate of probe packets that are sent by itself, which makes each node understand the bi-directional link quality information. According to probe packets, the system will maintain a neighbor table to store all the neighbor nodes, and establish a probe information table for each neighbor node to record its probe packets' sending and reception statistics.

The probe packet inspection cycle described above refers to the pre-configured time span that is used to count the statistical information of sent probe packets. This setting will be sent with the probe packets in order to allow a neighbor node count the amount of received probe packets among the above time span to calculate the packet loss rate. The packet loss rate will be recorded in the probe information table and be sent within the later probe packets.

Step 2, according to the above probe sending frequency and the number of received neighbor nodes' probe packets in different rates among unit testing cycle, the local node will calculate the success ratio of sending and receiving probe packets and send its probe packets including link quality information in unit testing cycle from the probe at the same time.

Step 3, depending on other information of neighbor nodes from the probe packets that the local node received, as well as the local node's information obtained from the received probe packets, the local node can calculate a statistical table storing the different rates of probe packages' received packet success ratio and sent package success ratio from itself to all adjacent nodes, which can be the initial basis for adaptive rate selection.

Step 4, based on the statistical table above, the local node will choose the optimal data transfer rate with all the adjacent nodes and record it to the priority rate table. The network initialization process is complete after this step.

Priority rate table described above refers to an optimal rate list which the local node, according to detection results, generates from the statistical table mentioned in the third step as a list of the best rates when communicating to the different adjacent nodes.

The optimal rate above is the communication speed of adjacent nodes in the initialization process.

Step 5, according to the priority rate table generated in the fourth step, the local node creates a new dynamic probe queue, selectively sends all the probe packet whose rates are the same or similar with the rates listed in the priority rate table, in other words the probe from the initialization probe queue with one higher level or one lower level rate than the rate in priority rate table, and on this basis, periodically sends the probe with lowest rate. At this point the network accesses rate-adaptive process, and the priority rate table and the dynamic probes queue will no longer be subject to the impact of the initialization process; only varies due to the received and sent states of each rate probe in the current dynamic probe queue. Therefore, the amount of dynamic detection probe queue reduces significantly; the sending cycle of probe queue abridges obviously; the adaptability of statistical table is enhanced greatly; the accuracy of priority rate table reflecting current channel quality is improved consequently.

The dynamic probe queue described above is the reset probe queue depending on the current selected rate, in particular, the queue removes the probe that has a considerable different rate with current communicate rate timely, retains the probe that can adapt to the change of current communication rate or that has the similar rate, and at the same time reserves the minimum rate probe for the maintenance of information transmission, as well as the most stable rate probe to ensure compliance with the minimum requirements for broadband transmission standard.

Step 6, when the network topology changes and is outside radio signal interferes, the network communication bandwidth will change, causing the probe received and sent power to change. When the decrease of network communication bandwidth cause a certain probe sent success ratio in priority rate table lower than the predetermined threshold A, that probe rate in priority rate table will be replaced by a lower rate. When the increase of network communication bandwidth causes a certain probe sent success ratio in priority rate table higher than the predetermined threshold B, that probe rate in priority rate table will be replaced by a higher rate. If the priority rate is up to 54 Mbps, the dynamic probe queue will send the three probes with the highest rate; if the priority rate dropped to 1 Mbps, the dynamic probe queue will send the three probes with the lowest rate.

The threshold above refers to the preset threshold that can trigger the variation of priority rate. When the probe sent success ratio of present priority rate probe is lower than threshold A, or the probe sent success ratio of the higher probe is higher than threshold B, the priority rate table will change subsequently. According to a large number of simulation and actual environmental testing, threshold As range is from 75% to 85%, while threshold B′s range is from 85% to 95%.

Step 7, when the priority-rate table changes, it will feedback to the dynamic probe queue. The dynamic probe queue repeats the fifth step, sixth step based on the latest priority-rate table, in order to ensure the current probe-sending queue set by the dynamic probe queue in line with monitoring requirements of the current adaptive rate. That is to say, while ensuring the detection of the current rate of communications, the node detects the adjacent high rate and low rate to ensure it can switch to the low rate when the current communication rate is not available, or switch to the high rate when the higher rate is available. By this method, the purpose of the dynamic rate adaptation can be achieved.

Compared with the existing technology, the present invention has the following beneficial effects: The present invention which takes into account the merits of active route records and passive route discovery effectively solve the problem of rate adaptation by using routing probe mechanisms. In the wireless Mesh network, the relatively fixed exit and the dynamic link make the present invention well adapted to the changes in the state of the network. The present invention can achieve the maximum reduction in the impact on throughput coursed by routing broadcasting and convergence and at the same time it takes into account changes in the network topology. For these reasons, the present invention is very suitable for the situation in the complex electromagnetic state of space.

Low consumption of network resources in the present invention is more applicable to a relatively lower-performance embedded hardware platform than PC platform. Following the 802.11a/b/g standards, the present invention is able to adapt to all existing wireless network rate, from 512 kbps to 54 Mbps. So it can make real-time adaptive rate options and has higher availability and reliability.

All these and other introductions of the present invention will become much clear when the drawings as well as the detailed descriptions are taken into consideration.

### BRIEF DESCRIPTION OF THE DRAWINGS

In order to explain the present invention in a more technical way, the attached figure will be described in the implementation of the present invention and analysis of existing technology. Obviously, the attached figure in the below descriptions is only an implementation example of the present invention. In the drawing:

FIG. 1 shows that the case of the present invention implements the adaptive rate in the case of topology change.

Like reference numerals refer to like parts throughout the several views of the drawings.

### DETAILED DESCRIPTION OF THE INVENTION

In order to describe the technical solutions and advantages of the present invention more clearly, the disclosure will be explained in details with the drawings. Here, the implementation example and its description of the present invention are just to explain the invention, but not to limit the invention.

The following is the detail description of the case of the present invention according to the attached figure. This case is implemented according to the technical solution of the present invention. Detailed implementation ways and specific operational process are given. The protection scope of the present invention is not limited to the following example.

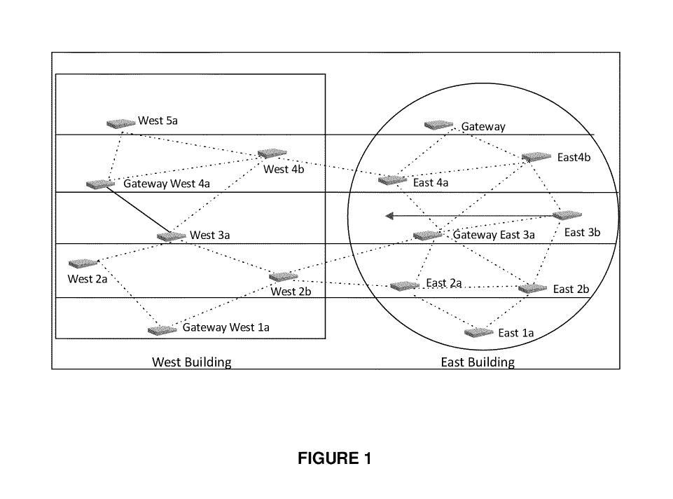

In this case a five-story exhibition hall is taken as an example. As shown in FIG. 1, each floor is divided into two halls, east and west. A node is placed in each hall on First floor and Fifth floor, that is, ‘East, 1a, ‘West 1a’, ‘East, 5a’, ‘West, 5a’. The east hall on Third floor is larger, so two nodes are placed in it: ‘East 3a’ and ‘East 3b’. ‘West 3a’ is placed in the west hall on Third floor. In the middle of the halls on Second and Fourth floor, there are bearing wall, so two nodes are placed in each hall: ‘East, 2a, ‘East, 2b’, ‘West 2a, ‘West, 2b’, ‘East, 4a, ‘East, 4b’, ‘West, 4a’, ‘West 4b’. There are fifteen nodes in total where ‘East, 3a’, ‘East, 5a’, ‘West, 4a’, ‘West 1a’ are gateway nodes.

This case of the present invention includes the following steps:

Step 1, the network initialization starts, powering on each Mesh node. Each wireless Mesh node loads a probe queue containing the entire communication rate supported by 802.11 and sends probe packets with a certain period of time interval. Meantime, the node also accepts the probe packets sent by other nodes. For example, the node ‘East, 3b’ in this case (the other nodes have the same behavior as it) will discover that node ‘East, 4b’, node ‘East, 2b’ and gateway node ‘East, 3a’ are its neighbor nodes in the First Step.

Step 2, according to the send frequency of the probe packets and the number of probe packets sent by the neighbor nodes with different rates in a unit testing period in the first step, the node calculates the success ratio of the sending and receiving probe packets. Meanwhile, the link quality information gained from the probe packets in a unit testing period is piggybacked on the probe packet and sent out.

The testing node ‘East, 3b’ records in local the success ratio of the sending and receiving probe packets with different rates from neighbor nodes and piggyback this information on the following probe to be broadcasted. Meantime, it is noted that the existence of other nodes in the network according to the probe packets from nodes ‘East, 4b’, ‘East, 2b’ and ‘East, 3a’. For example, according to Table 1, node ‘East, 3b’ can receive the probe with the rate of 2 Mbit/s from ‘West, 2b’, but these two nodes cannot communicate with each other in one hop, which means they are not neighbors.

Step 3, according to the information about neighbor nodes in the probe packets and the local information piggybacked on them. Through calculating, the node gains a statistical table on the success ratio of the sending probe packets and the receiving probe packets with different rates from neighbor nodes. This table is an initial basis of adaptive rate options. ‘East, 3b’ counts the success ratio of the sending and receiving probe packets with different rates and calculates the priority rate by sending and receiving the probes with neighbor nodes.

Step 4, according to the statistical table gained in the third step, as set forth above, as shown in Table 1, the local node will choose a priority rate at which it transmits data with neighbor nodes, and records the rate into priority-rate table. Till now, the network initialization process is complete. In this case, the priority rate is the communication rate determined in the initialization process of node ‘East, 3b’ with its neighbor nodes ‘East, 3a’, ‘East, 2b’, ‘East, 4b’ and node ‘West, 2b’ (As stated above, node ‘West, 2b’ is not the neighbor node of ‘East, 3b’, so they will not transmit data directly at the rate of 2 Mbit/s and will have multi-hop communication through node ‘East, 3a’);

Step 5, according to the priority-rate table in the fourth step, as set forth above, the local node establishes a new dynamic probe queue. It selectively sends all the probes at rates that are listed in the priority-rate table and are close to those listed in the table. On this basis, it continues to send probes at the lowest rate periodically. In this case, the priority-rate table of node ‘East, 3b’ records the priority rates at which it communicates with ‘East, 4b’ and ‘East, 3a’, which are 36 Mbit/s and 54 Mbit/s respectively. So in the dynamic probe queue, the rates of the related probes are 24 Mbit/s, 36 Mbit/s, 48 Mbit/s, 54 Mbit/s as well as the lowest rate 1 Mbit/s. Then the network enters rate adaption process.

Step 6, when we needs to adjust the local equipment or set the scent in the east hall on the third floor, node ‘East, 3b’ needs to be moved temporarily. The node moves nearer to node ‘East, 2a’ and node ‘West, 2b’ and farther from the node ‘East, 4b’, thus makes the network topology change. The success ratio of the sending and receiving probe packets between node ‘East, 3b’ and its neighbor nodes ‘East, 2a’, ‘East, 2a’, ‘East, 4b’ changes due to the change in physical distance. The priority communication rate between nodes ‘East, 3b’, ‘East, 2a’ and node ‘West, 2b’ increases as shown in Table 1. The priority communication rate between node ‘East, 3a’ and node ‘East, 4b’ decreases. The situation between node ‘East, 3b’ and node ‘East, 3a’ also has subtle change but doesn't meet the threshold, so the communication rate won't change. The threshold A and threshold B in this case are 85 and 95 respectively.

The experiment shows that the neighbor nodes in the network can choose the priority rate to communicate with each other according to the method the present invention provide. This method can ensure the maximum stability of the communication in the entire network. The situation will not happen that communication breaks down because the original communication rate cannot be met due to the decreasing of link quality when the communication rate is static.

Table 1 shows the change of the success ratio of sending probes and the priority rate in a testing period in this case

| | | Type of sending probe before | | | Priority | Type of sending probe after topology | | | Priority |
|---|---|---|---|---|---|---|---|---|---|
| Send | Receive | topology change (Mb) | | | rate | change (Mb) | | | rate |
| node | node | (success ratio) | | | (Mbit/s) | (success ratio) | | | (Mbit/s) |
| East, 2a | East, 3b | 24(100%) | 32(100%) | 36(84%) | 32 | 36(100%) | 48(100%) | 54(100%) | 54 |
| East, 3b | East, 2a | 32(100%) | 36(95%) | 48(92%) | 36 | 36(100%) | 48(100%) | 54(100%) | 54 |
| East, 3b | West, 2b | 1(95%) | 2(100%) | 5.5(60%) | 2 | 9(95%) | 11(100%) | 12(80%) | 11 |
| West, 2b | East, 3b | 1(90%) | 2(100%) | 5.5(55%) | 2 | 9(92%) | 11(100%) | 12(80%) | 11 |
| East, 3b | East, 3a | 36(95%) | 48(96%) | 54(100%) | 54 | 36(100%) | 48(92%) | 54(100%) | 54 |
| East, 3a | East, 3b | 36(93%) | 48(86%) | 54(100%) | 54 | 36(90%) | 48(100%) | 54(96%) | 54 |
| East, 3b | East, 4b | 24(90%) | 36(90%) | 48(75%) | 36 | 9(95%) | 11(100%) | 12(85%) | 11 |
| East, 4b | East, 3b | 24(60%) | 36(90%) | 48(80%) | 36 | 9(93%) | 11(100%) | 12(82%) | 11 |

| | | Type of sending probe before | | | Priority | Type of sending probe after another | | | Priority |
|---|---|---|---|---|---|---|---|---|---|
| Send | Receive | another topology change (Mb) | | | rate | topology change (Mb) | | | rate |
| node | node | (success ratio) | | | (Mbit/s) | (success ratio) | | | (Mbit/s) |
| East, 2a | East, 3b | 36(100%) | 48(100%) | 54(100%) | 54 | 24(100%) | 32(100%) | 36(70%) | 32 |
| East, 3b | East, 2a | 36(100%) | 48(100%) | 54(100%) | 54 | 32(90%) | 36(95%) | 48(80%) | 36 |
| East, 3b | West, 2b | 9(95%) | 11(100%) | 12(80%) | 11 | 1(100%) | 2(100%) | 5.5(34%) | 2 |
| West, 2b | East, 3b | 9(92%) | 11(100%) | 12(80%) | 11 | 1(100%) | 2(100%) | 5.5(20%) | 2 |
| East, 3b | East, 3a | 36(100%) | 48(92%) | 54(100%) | 54 | 36(90%) | 48(92%) | 54(100%) | 54 |
| East, 3a | East, 3b | 36(90%) | 48(100%) | 54(96%) | 54 | 36(90%) | 48(84%) | 54(97%) | 54 |
| East, 3b | East, 4b | 9(95%) | 11(100%) | 12(85%) | 11 | 24(91%) | 36(100%) | 48(79%) | 36 |
| East, 4b | East, 3b | 9(93%) | 11(100%) | 12(82%) | 11 | 24(50%) | 36(100%) | 48(82%) | 36 |

Step 7, when node ‘East, 3b’ moves back to the original place, repeat the fifth and sixth step, as set forth above. The communication rates of the node with other nodes adjust timely, as shown in Table 1.

The specific implementation as mentioned above explains the purpose of the present invention, technical programs and beneficial effects in further detail, while, it should be understood that the invention and its embodiments are not restricted to the above specific implementations but may vary within the scope of the claims. Any changes, equivalent replacing, improving within the spirit and principles of the present invention, should be included within the scope of protection of the present invention.

What is claimed is:

1. A rate-adaptive method for wireless mesh network, said method comprising:
a) Step 1, for each node in the wireless Mesh network, setting up a probe queue containing all communication rates supported by IEEE 802.11 standards, and sending probe packets periodically on fixed intervals, meanwhile receiving probe packets from other nodes and marking the nodes who send these received probe packets as neighboring nodes,
b) Step 2, based on the sending frequency of said probe packets used in said step 1 and the numbers of said probe packets of different rates received from said neighboring nodes during a unit detecting cycle, calculating the success ratio of sending and receiving said probe packets, and meanwhile generating a new probe packet with the link quality information during said unit detecting cycle which is achieved from those said probe packets, and sending said new probe packet into the network,
c) Step 3, based on the neighboring information in said probe packets received by the local node, and the local information stored in those received said probe packets, calculating a table containing said success ratio of sending packets and receiving packets between said local node and all said neighboring nodes, which will be considered as the initial basis for rate-adaptive selection,
d) Step 4, based on said table generated in said step 3, said local node choosing the best rate of data transmission with all said neighboring nodes, and recording it into rate priority table,
e) Step 5, based on said rate priority table generated in said step 4, said local node setting up a new dynamic probe queue, selectively sending probes whose rates are equal or close to those listed in said rate priority table,
f) Step 6, when there exists a probe with a certain rate in said rate priority table, whose said sending success ratio is less than 75%˜85%, its rate being reduced into a lower level, and when there exists a probe whose said sending success ratio when sent at a higher-level rate is greater than 85%˜95%, its rate being modified by said higher-level one, and when said priority rate rises up to 54 Mbps, said dynamic probe queue choosing said three kinds of probes with the highest rate to send, and when said priority rate drops down to 1 Mbps, said dynamic probe queue choosing said three kinds of probes with the lowest rate to send, and
g) Step 7, when said rate priority table changes, it sending feedback to said dynamic probe queue, and said dynamic probe queue repeating said step 5 and said step 6 based on said latest rate priority table.

2. A method as recited in claim 1 wherein said probe packets are broadcasting packets, containing the ID (Identifier) of its original node, the type of the node, the SNR (signal noise rate) of the node, the probes' send delay and send interval of the node, the number of all probes sent by the node during a probe detecting cycle, and the receiving rate of the node of said probe packets from said neighboring nodes.

3. A method as recited in claim 1 and claim 2 wherein said detection cycle of a probe packet refers to the time span during which the number of said probe packets sent are counted.

4. A method as recited in claim 1 wherein said rate priority table refers to a list of optimal rates based on the detection results, which are used when communicating with different adjacent nodes.

5. A method as recited in claim 1 wherein said optimal rate refers to the selected communication rate between said adjacent nodes during the initial process.

6. A method as recited in claim 1 wherein said dynamic priority queue removes the probes whose rates are relatively more different from the current communication rate, and maintains the probes which can adapt said current communication rate dynamically, and the probes whose rates are close to the former ones and those with the lowest rates.
